(19) United States
(12) Patent Application Publication
(10) Pub. No.: US 2010/0217564 A1
(43) Pub. Date: Aug. 26, 2010

(54) ADVANCED PHYSICAL SIMULATOR

(76) Inventors: Juergen K. Lahner, Morgan Hill, CA (US); Balamurugan Balasubramanian, San Jose, CA (US); Kavitha Chaturvedula, San Jose, CA (US)

Correspondence Address: CHRISTOPHER P MAIORANA, PC;LSI Corporation, 24840 HARPER, SUITE 100, ST CLAIR SHORES, MI, 48080, US

(21) Appl. No.: 12/393,358

(22) Filed: Feb. 26, 2009

(51) Int. Cl. G06F 17/50

(52) U.S. Cl. 703/1; 703/14

(57) ABSTRACT

A method of physical simulation of an integrated circuit design comprising the steps of (A) reading design information for an integrated circuit from a computer readable storage medium, (B) reading library information and physical design information from the computer readable storage medium, (C) simulating the integrated circuit design based upon the library information and the physical design information using a computer, where the simulation of the integrated circuit design provides signoff accurate results and (D) determining whether the integrated circuit design meets one or more performance goals based upon results of the simulation of the integrated circuit design.

### FIELD OF THE INVENTION

The present invention relates to electronic design generally and, more particularly, to a method and/or apparatus for implementing an advanced physical simulator.

### BACKGROUND OF THE INVENTION

Digital integrated circuit designs can include application specific integrated circuits (ASICs) and application specific standard products (ASSPs). Simulation for digital design is performed using simulators including VCS, NCVerilog, and Modelsim. Simulation for digital design is limited because accurate timing (i.e., signoff timing) is not available from conventional simulators. Conventional simulators do not read spef files (i.e., files containing physical data). Conventional simulators do not include delay engines. Conventional simulators read standard delay format (SDF) files. The SDF files that can be read into conventional simulators contain delay estimates for nets rather than signoff accurate timing information. For example, crosstalk impact on clock nets is not accurately captured. Conventional simulators do not consider power consumption/supply information during simulation. Conventional simulators do not provide signoff quality simulation results.

There are a number of existing approaches toward solving the above problems. To address timing concerns, Hspice simulation can be run or a combination of simulation and static timing analysis (STA) can be performed. However, Hspice simulation is not reasonable due to the huge amount of data and run times. The combination of simulation and static timing analysis reduces, but does not eliminate, the risk of inaccurate simulation results.

To address power concerns, Hspice simulations can be run. However, as mentioned above, Hspice simulations are not reasonable due to the huge amount of data and run times. Additional tools can be run to evaluate/predict power status (i.e., demand vs. supply). However, simulation results can be invalid if power planning and implementation is not done correctly.

To address signing off of a chip, a combination of signoff tools/strategies including Hspice and STA can be used, but none can be used as a stand-alone method to tape out a chip. Existing approaches have a risk of failure in the area of functional verification. Also, existing approaches provide inefficient verification of a design by independently running power analysis, timing analysis and functional verification in parallel.

It would be desirable to have a physical simulator that provides accurate, signoff quality results.

### SUMMARY OF THE INVENTION

The present invention concerns a method, which in an example embodiment provides advance physical simulation, including the steps of (A) reading design information for an integrated circuit from a computer readable storage medium, (B) reading library information and physical design information from the computer readable storage medium, (C) simulating the integrated circuit design based upon the library information and the physical design information using a computer, where the simulation of the integrated circuit design provides signoff accurate results and (D) determining whether the integrated circuit design meets one or more performance goals based upon results of the simulation of the integrated circuit design.

The objects, features and advantages of the present invention include providing an advanced physical simulator that may (i) provide simulation results with signoff quality, (ii) provide simulation results based on signoff data, (iii) provide simulation results reflecting power up/down sequences, (iv) provide simulation results reflecting impact of crosstalk, (v) reduce risks (e.g., silicon failure, functional risks, etc.), (vi) reduce turnaround time (TAT), (vii) provide an efficient signoff verification strategy, (viii) allow realistic planning of resources for simulation and design completion, (ix) allow extraction of data/recommendations to guide design closure (e.g., placement and power planning) and/or (x) allow qualification of library files based upon existing chip design.

### BRIEF DESCRIPTION OF THE DRAWINGS

These and other objects, features and advantages of the present invention will be apparent from the following detailed description and the appended claims and drawings in which:

FIG. 1 is a flow diagram illustrating an example timing analysis process in accordance with an embodiment of the present invention;

FIG. 2 is a flow diagram illustrating an example power analysis process in accordance with an embodiment of the present invention;

FIG. 3 is a block diagram illustrating an example apparatus implementing an advanced physical simulator in accordance with an embodiment of the present invention; and

FIG. 4 is a flow diagram illustrating an example library qualification process in accordance with an embodiment of the present invention.

### DETAILED DESCRIPTION OF THE PREFERRED EMBODIMENTS

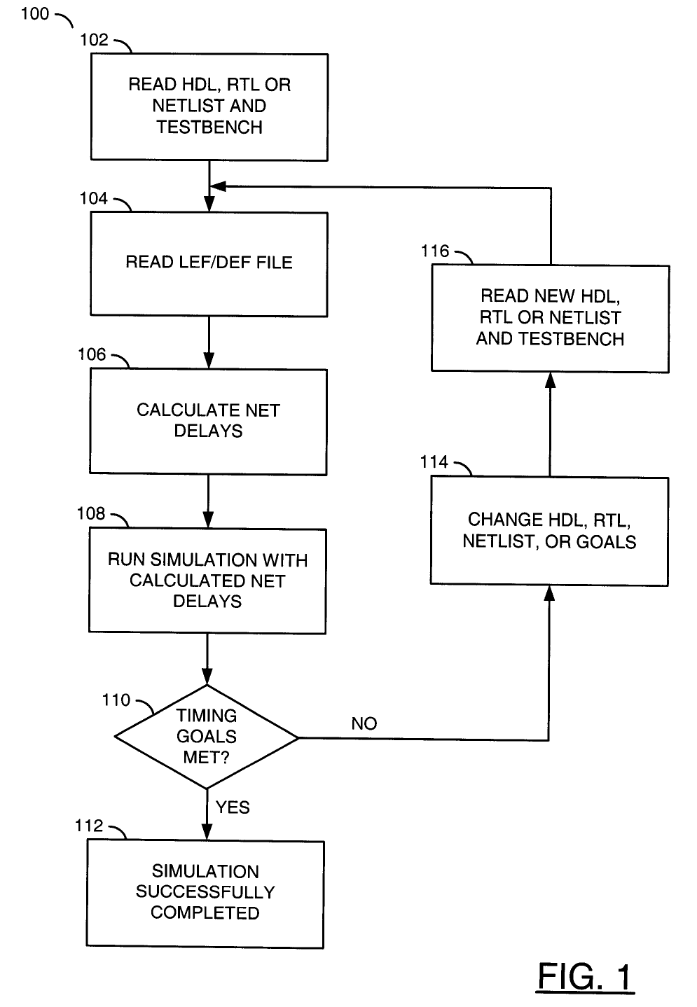

Referring to FIG. 1, a flow diagram is shown illustrating a process 100 in accordance with a preferred embodiment of the present invention. The process 100 may provide a signoff accurate timing analysis. The process 100 may comprise a step 102, a step 104, a step 106, a step 108, a step 110, a step 112, a step 114 and a step 116. Each of the steps 102-116 may be implemented, for example, as a step, a process, a subroutine, a state in a state diagram, or another type of step/state and/or process and/or state. In the step 102, a circuit description comprising, for example, hardware description language (HDL) (e.g., register transfer level (RTL), etc.) information or netlist information and testbench information may be read from computer readable storage media. In the step 104, cell library data, process information and physical design information may be read from the computer readable storage media. The cell library data and process information may be stored, in one example, on the computer readable storage media as a library exchange format (LEF) file. The physical design information (e.g., description of the particular chip design being simulated) may be stored, in one example, on the computer readable storage media as a design exchange format (DEF) file. The combination of cell library data, process information, and physical design information may be referred to generally as a lef/def file. While LEF and DEF files are used herein as examples of library information and physical design information files, respectively, it will be understood by those skilled in the art that library information and physical design information may be stored using other equivalent file formats, file names and/or extensions without departing from the scope of the invention.

In the step 106, net delays may be calculated based upon the cell library data, the process information and the design information using a computer. The process 100 may read a lef/def file to process/calculate the net delays. The lef/def file generally contains the actual route information for signals, instead of the estimated delay values as found in an SDF file. For simulation, the process 100 generally calculates the delay values by looking at active RC values for the net in a current state, which may be more accurate. Also, since the process 100 may access all the routing information, crosstalk, noise and common clock path related calculations for timing may be more accurate. When the net delays have been calculated, the process 100 may move to the step 108.

In the step 108, a simulation of the integrated circuit design described by the HDL, RTL, netlist, cell library data, process information and physical design information may be performed using the computer. In the step 110, the computer may be instructed to determine whether particular goals (e.g., timing, etc.) have been met based upon results of the simulation run in the step 108. When the timing goals are met, the process 100 may move to the step 112 where the simulation may terminate.

When the computer determines that the timing goals have not been met, the process 100 may move to the step 114. In the step 114, the designer may make changes to the HDL, RTL, the netlist and/or the goals. When the HDL, RTL, netlist and/or goal changes have been made, the process 100 may move to the step 116. In the step 116, the process 100 may read the new HDL, RTL or netlist, and testbench information and return to the step 104. The process 100 may be repeated until the computer determines, based upon the simulation results, that the particular (e.g., timing, etc.) goals are met.

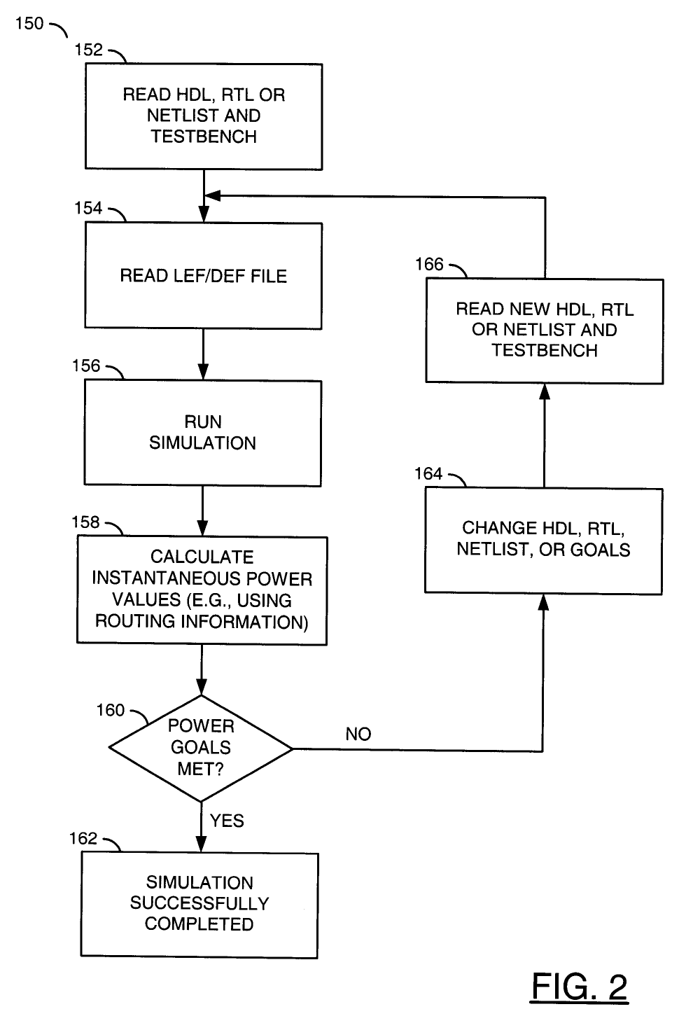

Referring to FIG. 2, a flow diagram is shown illustrating a process 150 in accordance with an embodiment of the present invention. The process 150 may provide a signoff accurate power analysis. The process 150 may comprise a step 152, a step 154, a step 156, a step 158, a step 160, a step 162, a step 164 and a step 166. Each of the steps 152-166 may be implemented, for example, as a step, a process, a subroutine, a state in a state diagram, or another type of step/state and/or process and/or state. In the step 152, a circuit description (e.g., HDL, RTL, netlist, etc.) and testbench information are read. In the step 154, cell library data, process information and physical design information may be read from files stored on one or more computer readable storage media. The files may be implemented, in one example, as library exchange format (lef) files and design exchange format (def) files. The cell library data, process information and physical design information may be referred to generally as a lef/def file.

In the step 156, simulation may be run based upon the cell library data, the process information and the physical design information using a computer. For example, the step 156 may calculate net delays and run a simulation similarly to the steps 106 and 108 described above in connection with FIG. 1. In the step 158, instantaneous power values may be calculated by the computer using routing information from the step 156. Power state transitions, and verification of multiple power domain designs may be more accurate because, the accurate value of the voltages on the power rails may be calculated instead of using an approximation. In the step 160, the computer may be configured to determine whether one or more power goals are met. When the power goals are met, the process 150 may move to the step 162 to terminate the simulation.

When the power goals are determined not to have been met, the process 150 may move to the step 164, where the designer may make changes in the HDL, RTL, the netlist and/or the goals to be met. Once the designer has made the changes to the HDL, RTL, the netlist and/or the goals, the process 150 may move to the step 166. In the step 166, the process 150 may read the new HDL, RTL or netlist and testbench information and return to the step 154. The process 150 may be repeated until the simulator determines that the power goals are met.

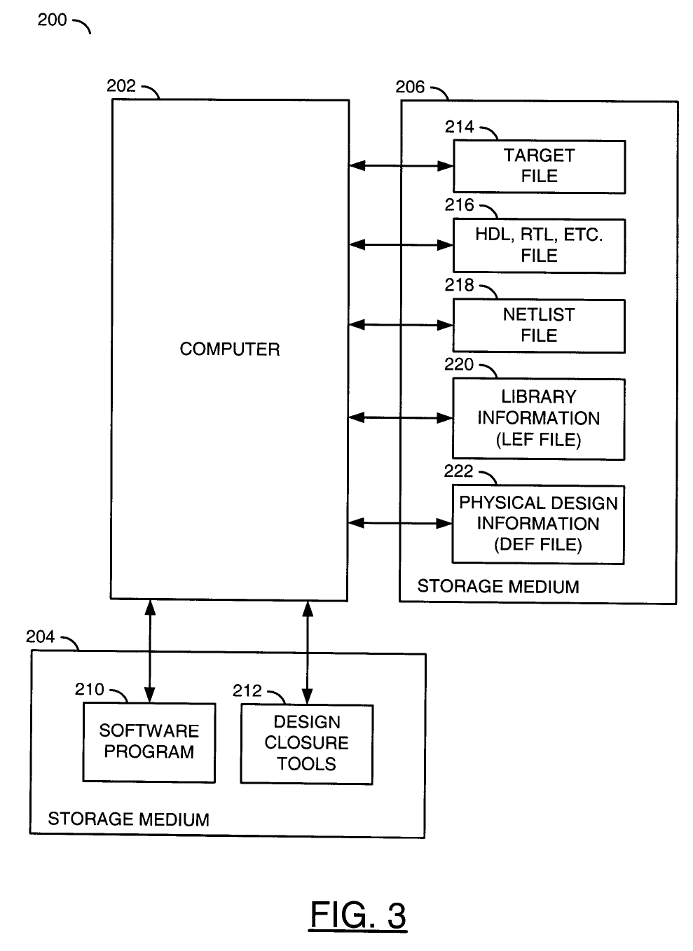

Referring to FIG. 3, a block diagram is shown illustrating an example of an apparatus 200 implementing an advanced physical simulator in accordance with the present invention. The apparatus 200 may be implemented, in one example, as a computer 202 and one or more computer readable storage media. In one example, the apparatus 200 may comprise a storage medium 204 and a storage medium 206. The storage medium 204 may store one or more software programs 210 and one or more design closure tools 212. The software programs 210 may implement, for example, steps similar to the processes 100 and 150 (described above in connection with FIGS. 1 and 2). The design closure tools 212 may be operational to perform synthesis, floorplanning, placement, routing and related layout tasks.

The storage medium 206 may store, in one example, a file 214, a file 216, a file 218, a file 220 and a file 222. The file 214 may contain predetermined target goals and/or target goals calculated by the software program 210. The file 216 may contain a circuit description using a hardware description language (e.g., HDL code, RTL code, etc.) representation of a chip design being created. The file 218 may contain a netlist of the chip being created. The file 220 may contain cell library data and process information to be used by the software program 210. The file 222 may contain physical design information for the integrated circuit design. The files 220 and 222 may be implemented as one or more lef/def files.

The software program 210 and tool programs 212 may be read and executed by the computer 202. The computer 202 and programs 210 and 212 may access the chip design data in the files 214-222 to perform an advanced physical simulation in accordance with embodiments of the present invention.

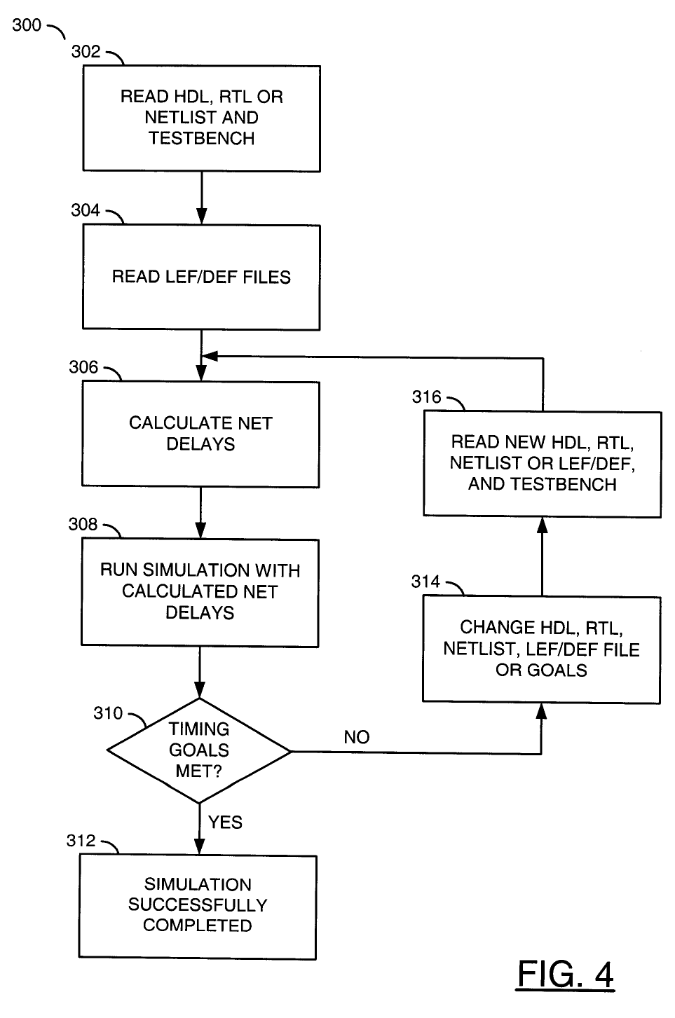

Referring to FIG. 4, a flow diagram is shown illustrating a process 300 in accordance with an embodiment of the present invention. The process 300 may be implemented, in one example, as a library qualification process. In one example, the process 300 may be used to qualify a new cell library based upon an existing chip design. The process 300 may comprise a step 302, a step 304, a step 306, a step 308, a step 310, a step 312, a step 314 and a step 316. Each of the steps 302-316 may be implemented, for example, as a step, a process, a subroutine, a state in a state diagram, or another type of step/state and/or process and/or state. In the step 302, a description of an existing circuit (e.g., hardware description language (HDL) code, register transfer level (RTL) information or netlist information) and testbench information for an existing chip design may be read from a computer readable storage medium. In the step 304, cell library data, process information and physical design information may be read from the computer readable storage medium. The cell library data and process information may be stored, in one example, on the computer readable storage medium as a library exchange format (LEF) file. The physical design information may be stored, in one example, on the computer readable storage medium as a design exchange format (DEF) file. The cell library data, the process information and the physical design information may be referred to generally as a lef/def file.

In the step 306, net delays may be calculated based upon the cell library data, the process information and the physical design information using a computer. When the net delays have been calculated, the process 300 may move to the step 308. In the step 308, a simulation of the existing integrated circuit design may be run based upon the HDL, RTL or netlist information, the testbench information, the cell library data, the process information and the physical design information, using the computer. In the step 310, the computer may be instructed to determine whether timing goals have been met based upon results of the simulation run in the step 308. When the timing goals have been met, the process 300 may move to the step 312 where an indication may be presented that the simulation was completed successfully. Successful completion of the simulation may signal successful qualification of the lef/def file based upon the existing chip design.

When the simulator determines that the timing goals are not met, the process 300 may move to the step 314. In the step 314, the designer may make changes to the HDL, RTL, the netlist, the lef/def file and/or the goals. When the HDL, RTL, netlist, lef/def file and/or goal changes have been made, the process 300 may move to the step 316. In the step 316, the process 300 may read the new HDL, RTL, netlist or lef/def file, and testbench information and return to the step 306. The process 300 may be repeated until the computer determines, based upon the simulation results, that the particular goals are met by the lef/def file.

By adding the capability of accurate delay and power calculation directly into the simulation (e.g., using the routing information in the form of lef or def files) for timing and power verifications, the number of tools in a design flow may be reduced and the efficiency increased. The simulation results may be more accurate and may have signoff quality because the verification results are based on actual power calculation and signoff timing rather than estimated values.

An advanced physical simulator implemented in accordance with embodiments of the present invention may (i) provide simulation results with signoff quality, (ii) provide simulation results based on signoff data, (iii) provide simulation results reflecting power up/down sequences, (iv) provide simulation results reflecting impact of crosstalk, (v) reduce risks (e.g., silicon failure, functional risks, etc.), (vi) reduce turnaround time (TAT), (vii) provide an efficient signoff verification strategy, (viii) allow realistic planning of resources for simulation and design completion, (ix) allow extraction of data/recommendations to guide design closure (e.g., placement and power planning) and/or (x) allow qualification of library files based upon existing chip design.

The functions illustrated by the diagrams of FIGS. 1, 2 and 3 may be implemented using one or more of a conventional general purpose processor, digital computer, microprocessor, microcontroller, RISC (reduced instruction set computer) processor, CISC (complex instruction set computer) processor, SMID (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method of physical simulation of an integrated circuit design comprising the steps of:
reading design information for an integrated circuit from a computer readable storage medium;
reading library information and physical design information from said computer readable storage medium;
simulating the integrated circuit design based upon the library information and the physical design information using a computer, wherein the simulation of the integrated circuit design provides signoff accurate results; and
determining whether the integrated circuit design meets one or more performance goals based upon results of the simulation of the integrated circuit design.

2. The method according to claim 1, wherein the design information for the integrated circuit comprises a hardware description language (HDL) code and testbench information.

3. The method according to claim 1, wherein the design information for the integrated circuit comprises register transfer level (RTL) code and testbench information.

4. The method according to claim 1, wherein the design information for the integrated circuit comprises netlist and testbench information.

5. The method according to claim 1, wherein the library information is stored in a library exchange format (lef) file and the physical design information is stored in a design exchange format (def) file.

6. The method according to claim 1, wherein the one or more performance goals comprise timing goals.

7. The method according to claim 1, wherein the one or more performance goals comprise power goals.

8. The method according to claim 1, further comprising the steps of:
calculating one or more net delays based upon actual route information contained within said library information and said physical design information; and
calculating delay values during simulation by looking at active RC values for current states of one or more nets.

9. The method according to claim 7, further comprising the step of:
calculating instantaneous power values based upon routing information generated during said simulation.

10. The method according to claim 1, further comprising the steps of:
modifying one or more of the design information for the integrated circuit, the library information, the physical design information and the one or more performance goals if the simulation results indicate that the performance goals are not met;
reading the modified information; and
repeating the simulation, determining and modifying steps until the one or more performance goals are met.

11. A physical simulator tool comprising processor executable instructions stored in a computer readable medium, the processor executable instructions configured to perform the steps of:
reading design information for an integrated circuit from a computer readable storage medium;
reading library information and physical design information from said computer readable storage medium;
simulating the integrated circuit design based upon the library information and the physical design information using a computer, wherein the simulation of the integrated circuit design provides signoff accurate results; and
determining whether the integrated circuit design meets one or more performance goals based upon results of the simulation of the integrated circuit design.

12. The physical simulator tool according to claim 11, wherein the design information for the integrated circuit comprises one or more of hardware description language (HDL) code, register transfer level (RTL) code, netlist information and testbench information.

13. The physical simulator tool according to claim 11, wherein the library information is stored in a library exchange format (lef) file.

14. The physical simulator tool according to claim 11, wherein the physical design information is stored in a design exchange format (def) file.

15. The physical simulator tool according to claim 11, wherein the one or more performance goals comprise timing goals.

16. The physical simulator tool according to claim 11, wherein the one or more performance goals comprise power goals.

17. The physical simulator tool according to claim 11, wherein the processor executable instructions are further configured to perform the steps of:
calculating one or more net delays based upon actual route information contained within said library information and said physical design information; and
calculating delay values during simulation by looking at active RC values for current states of one or more nets.

18. The physical simulator tool according to claim 17, wherein the processor executable instructions are further configured to perform the step of:
calculating instantaneous power values based upon routing information generated during said simulation.

19. The physical simulator tool according to claim 11, wherein the processor executable instructions are further configured to perform the steps of:
modifying one or more of the design information for the integrated circuit, the library information, the physical design information and the one or more performance goals if the simulation results indicate that the performance goals are not met;
reading the modified information; and
repeating the simulation, determining and modifying steps until the one or more performance goals are met.

20. A computer readable medium containing processor executable instructions, the processor executable instructions configured to perform the steps of:
reading design information for an integrated circuit from a computer readable storage medium;
reading library information and physical design information from said computer readable storage medium;
simulating the integrated circuit design based upon the library information and the physical design information using a computer, wherein the simulation of the integrated circuit design provides signoff accurate results;
determining whether the integrated circuit design meets one or more performance goals based upon results of the simulation of the integrated circuit design.
